(19) United States
(12) Patent Application Publication
(10) Pub. No.: US 2009/0261044 A1
(43) Pub. Date: Oct. 22, 2009

(54) ENVIRONMENTAL MONITORING AND CONTROL SYSTEM AND METHOD

(76) Inventors: Scott GODLIEN, Cochrane (CA); Gary Russell, Bentley (CA)

Correspondence Address: HESLIN ROTHENBERG FARLEY & MESITI PC, 5 COLUMBIA CIRCLE, ALBANY, NY, 12203, US

(21) Appl. No.: 12/425,883

(22) Filed: Apr. 17, 2009

Related U.S. Application Data
(60) Provisional application No. 61/045,822, filed on Apr. 17, 2008.

(30) Foreign Application Priority Data
Apr. 17, 2008 (CA) 2,629,422

(51) Int. Cl. B01D 21/34; B01D 35/14; B01D 21/30; B01D 21/02

(52) U.S. Cl. 210/744; 210/97; 210/86

(57) ABSTRACT

An environmental monitoring and control system and method are provided for preventing overflow of fluid from a compartment continuous with a settling tank. The system includes an improved pump configuration to minimize pump failure and maintenance, as well as monitoring of fluid volume within the compartment and adjustment of pumping rate as necessary to maintain an appropriate fluid volume. Operators on or off-site may be notified of compartment fluid volume to provide further redundancy.

### FIELD OF THE INVENTION

The present invention relates generally to the handling of clarified drilling fluids. More particularly, the invention provides an environmental control system for reliable handling of clarified fluid at a drilling site.

### BACKGROUND OF THE INVENTION

Downhole drilling operations are generally performed at remote locations, and it is therefore desirable to reuse or recycle as many resources as possible on-site and to minimize environmental impact. Moreover, equipment must be reliable as on-site repair and replacement of components is inconvenient and costly. Further, equipment failure may cause excessive environmental impact if drilling fluids are spilled onto the site or otherwise make their way into nearby lakes and streams.

During clearwater drilling, fluid is pumped downhole through the drill string to the drill bit, and is returned to the surface as a slurry, carrying cuttings and suspended solids. The slurry is typically clarified on site by settling solids from the slurry, with the resulting clear fluid recycled for use in further drilling. At various stages of drilling, different drilling fluid compositions are required, and it is preferable that each type of drilling fluid is similarly clarified and recycled to conserve resources and minimize environmental damage.

In clarification systems incorporating primarily gravity-based settling means, a horizontal settling tank system may be used to provide a long flowpath for passage of the fluid, maximizing fluid retention time within the system and providing sufficient opportunity for solids to settle from the fluid. Once the fluid stream has passed through the clarification system, solids have settled at the bottom of the tank, and the drilling fluid has been sufficiently clarified that it may be reused downhole. Such clarified fluid may be held within a clarified fluid compartment continuous with the settling tank, with clarified fluid pumped out of the compartment for use downhole as needed.

A fluid clarification system has been previously described by Godlien in U.S. Patent Pub. No. 2008/0121589 μl, filed May 31, 2007, which is incorporated herein by reference. The application describes, in one embodiment, a horizontal settling tank divided into compartments. The final compartment is a clarified fluid compartment, from which fluid is pumped back to the drill string for reuse.

As changing drilling conditions may impact slurry characteristics, the clarification parameters and required slurry retention time may change over the course of one project. Therefore, the fluid volume within the clarified fluid compartment of a settling tank may fluctuate. At times, clarified fluid may be produced more quickly than it is reused, filling the clarified fluid compartment. At other times, clarified fluid may be used in drilling operations more quickly than it is clarified. As such, access to high capacity pumping from the clarified fluid compartment is required but this capacity may be required only infrequently.

It is typical in the art to use submersible pumps within clarified fluid compartments of settling tanks due to the portability, small size, and relatively low cost of these pumps. However, submersible pumps are prone to failure due to these very features. A portable pump is not fixed in a permanent position, so it may be damaged during operation or transport. Portable pumps require frequent maintenance due to worn seals and shafts, fluid entry into the motor causing motor failure, etc. Further, as such pumps are constantly submerged in fluid during use, individual components may rust and fail. Still further, in addition to poor reliability, the capacity of these pumps is limited by the small space typically available within the compartment. Generally, two small pumps are placed in a clarified fluid compartment in order to accommodate temporary increases in pumping demand. Should one or both of the pumps fail, overflow of the clarified fluid compartment is likely. When the clarified fluid compartment is continuous with a settling tank, backup of clarified fluid may cause overflow of the settling tank, depositing raw drilling fluid on the ground. The spilled drilling fluid may contain chemicals or other additives that could be detrimental to soil, vegetation, and surface waters surrounding the site.

Accordingly, it is desirable to provide a system for minimizing environmental damage at a drilling site.

### SUMMARY OF THE INVENTION

In accordance with a first embodiment of the invention, there is provided an environmental control system for use with a fluid compartment continuous with a settling tank, the environmental control system comprising: a stationary pump for removing fluid from the compartment; and a fluid volume monitoring and control system for adjusting operation of the pump based on the volume of fluid within the compartment.

In an embodiment, the stationary pump comprises a submersible pump for placement within a fluid compartment; and a motor operatively attached to the pump so as to drive fluid removal from the compartment. The motor is attached such that it remains unsubmerged in the tank fluid during use.

The fluid monitoring and control system may comprise one or more fluid level sensors within the compartment. Further, the fluid monitoring and control system may comprise notification means for communicating compartment fluid volume information to an operator.

In an embodiment, the motor is operated by a variable frequency drive based on the fluid level within the compartment.

In another embodiment, the motor is operated by level switches within the compartment to maintain the fluid level within the compartment between predetermined limits.

The system may further comprise a processor for receiving volume data from the fluid compartment, and for initiating a preset adjustment scheme. The preset adjustment scheme may involve adjustment of the rate of fluid flow from the compartment; activation of an alarm; termination of a local fluid handling process; dumping of fluids into a storage tank and/or any other suitable step to prevent overflow or otherwise limit environmental damage.

The fluid mentioned in the above embodiments may be drilling fluid, drilling slurry, clarified fluid, or any fluid that may negatively impact the surrounding environment should overflow occur.

In accordance with a second aspect of the invention, there is provided a method for preventing overflow of a fluid compartment continuous with a settling tank, the method comprising the steps of: placing a submersible pump within the fluid compartment, the submersible pump driven by a motor operatively attached to the pump by an impeller shaft such that the pump is operable by the motor without the motor being submerged within the compartment fluid; operating the pump to remove fluid from the compartment; sensing fluid volume within the compartment; and communicating fluid volume data to an operator. The method may further comprise the step of adjusting pump operation based on the fluid volume within the compartment.

In accordance with a third aspect of the invention, there is provided a method for preventing overflow of a fluid compartment continuous with a settling tank, the method comprising the steps of: placing a submersible pump within the fluid compartment, the submersible pump driven by a motor operatively attached to the pump by an impeller shaft such that the pump is operable by the motor without the motor being submerged within the compartment fluid; sensing fluid volume within the compartment; and adjusting pump operation based on sensed compartment fluid volume. The method may further comprise the step of communicating sensed fluid volume data to an operator.

In accordance with the second or third above-mentioned aspects of the invention, embodiments may further comprise the step of: notifying an operator if the compartment fluid volume reaches a predetermined limit.

Still further, the method may comprise the step of processing sensed fluid volume data and implementing a predetermined scheme to adjust compartment fluid volume.

The scheme may involve adjusting the amount of power to the motor; activation of an alarm; dumping of fluid from the compartment or from the settling tank; termination of a fluid handling process; and/or any other step to minimize risk of overflow or damage to the site.

The operator mentioned above may be located on site or remotely, and may be any person responsible for the monitoring, control, maintenance, or supervision of fluid handling.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a side cross-sectional schematic view of a settling tank and clarified fluid compartment;

FIG. 2 is a perspective view of the clarified fluid compartment shown in FIG. 1;

FIG. 3 is a side cross sectional schematic view of a clear fluid compartment in one embodiment; and

FIG. 4 is a flow diagram showing a fluid volume monitoring and control process.

### DETAILED DESCRIPTION

Generally, the present invention provides an environmental control system for a clarified fluid compartment. The clarified fluid compartment receives clarified fluid from a settling tank and clarified fluid is pumped from the compartment for storage or use of this recycled fluid.

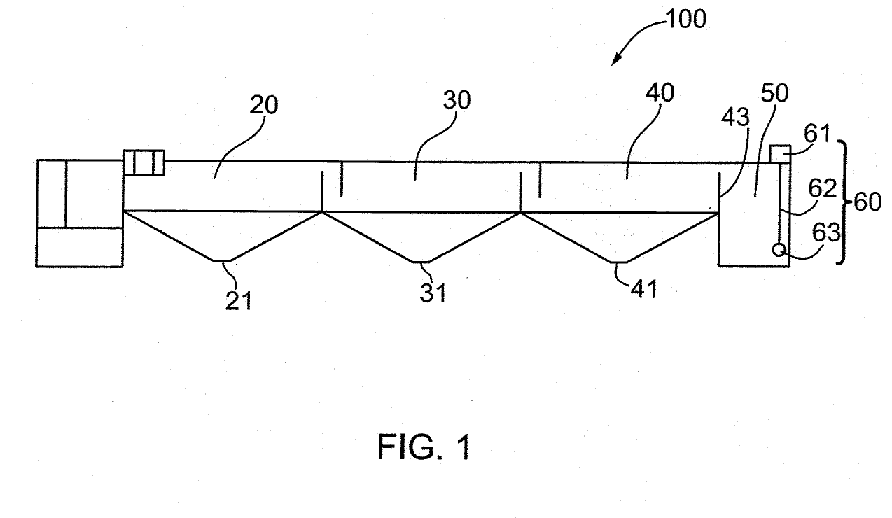

With reference to FIG. 1, a clarifying system 100 is shown in which a tank is divided into various compartments. Slurry feed enters the tank and passes through settling compartments 20, 30, and 40, to clarified fluid compartment 50. Solids fall from the slurry in each settling compartment 20, 30, and 40 and concentrate at the solids outlets 21, 31, and 41 of each respective compartment. Tank compartments 20, 30, 40, and 50 are separated from one another by weir and baffle systems such that fluid flows generally from tank compartment 20 to the clarified fluid tank 50. The number and size of settling compartments and clarified fluid compartments may be varied as necessary.

A clarifying system may generally be manufactured as a single divided tank for transport to the job site on a trailer or skid, or the system may be made up of one or more independently transported fluid compartments. Several types of settling tanks are known in the art, and the present environmental control system may be used with tanks of any configuration. Specifically, certain aspects of the environmental control system described below may be used with any settling compartment, clarified fluid compartment, or any on-site fluid containment compartment that receives and discharges fluid from time to time.

Fluid is removed from clarified fluid compartment 50 by stationary pump 60. The clarified fluid removed from the compartment 50 may be sent to the drill string for immediate reuse, to a holding tank, or used for other purposes. The stationary pump 60 includes a motor 61, which sits above or outside of the clarified fluid compartment 50; a pump 63 for drawing fluid from the clarified fluid compartment 50, and a shaft 62 for communicating fluid from the pump 62 past the motor 61 and to an appropriate conduit (not shown).

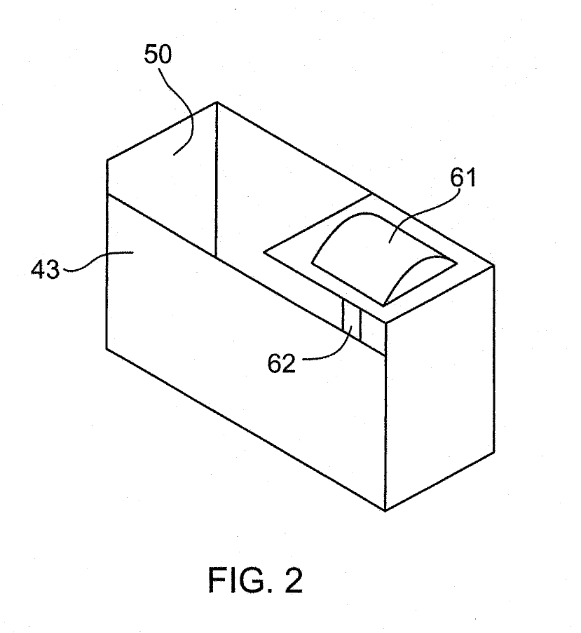

In the embodiment shown in FIGS. 1 and 2, the clear fluid compartment 50 is separated from settling compartment 40 by a weir wall 43. Thus, the fluid volume within clarified fluid compartment 50 is generally lower than that in settling compartment 40. Should the clarified fluid not be removed from the compartment 50 at a rate greater than the rate at which newly clarified fluid is entering compartment 50 (from the settling compartment 40 over weir wall 43), the fluid level in the clarified fluid compartment 50 will rise and may overflow weir wall 43, flooding settling compartment 40. The rate of fluid removal by the stationary pump 60 may therefore be adjusted to accommodate such variations in capacity.

### Stationary Pump

The stationary pump 60 shown in the drawings is provided as a sample configuration of a suitable fluid pump for removing fluid from the compartment. The pump shown in the drawings was modified to separate the pump from the motor by an impeller shaft. A stationary pump is more suitable than typical submersible pumps, as such pumps can typically handle a greater capacity than the pumps currently used in settling tanks for pumping of clarified fluids. Moreover, as the motor is not submerged within the clarified fluid, motor components are less susceptible to water damage and failure. Further, as space to accommodate the motor is not limited by the volume of the compartment, the volume of the compartment does not limit the motor size, and thus capacity of the pump.

### Control System

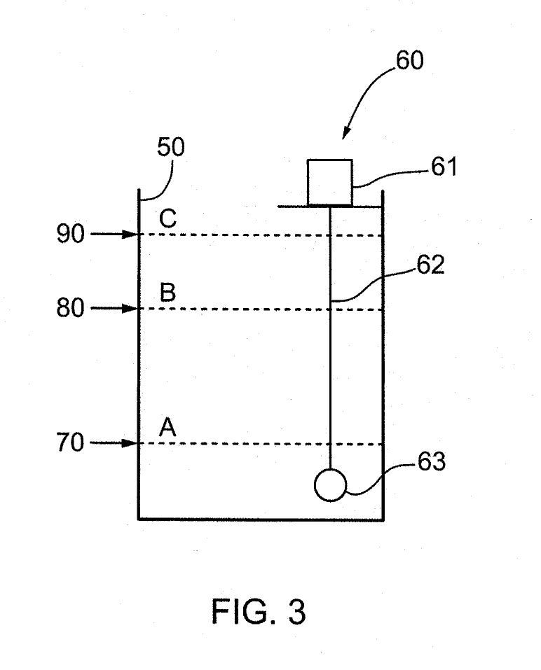

The fluid level within compartment 50 should be maintained at sufficient height to cover the fluid intake opening of stationary pump 60. The fluid level is preferably maintained above the height of the pump 63, as indicated in FIG. 3 by minimum fluid level A. Similarly, the fluid volume within compartment 50 should also be maintained a sufficient distance below the top of the compartment to allow additional depth to accommodate variations in flow in and out of the compartment. The normal fluid maximum B is indicated in FIG. 3.

While the pumping rate of stationary pump 60 may be adjusted manually by an operator based on visual inspection of the fluid volume within clarified fluid compartment 50, the discharge flow from pump 60 is preferably automated. Such monitoring and control system may be configured using any combination of sensors, switches, processors, components, cameras, valves, and circuitry to maintain the fluid volume within preset acceptable limits.

For example, the motor may be operated by a variable frequency drive (VFD) and processor based on fluid level determination, or by fluid level switches that switch the motor on and off at preset fluid levels. Further, level sensors within the tank may communicate with a control valve to adjust flow rate into the compartment, into the pump, or from the compartment.

With reference to FIG. 3, level sensors may be placed within the clarified fluid compartment 50 at a minimum fluid level A, a normal fluid maximum B, and at an emergency depth C. Additional sensors may also be placed within the compartment at additional depths to enable precise, continuous, remote monitoring of the fluid volume. The fluid monitoring and control system shown also includes a processor for processing data received from the level sensors; a VFD for operating the pump 60 in response to said data processing; and notification means for communication volume status to operators. Examples of suitable notification means may include: an audible or visual alarm for warning on-site operators that fluid within the compartment has reached a particular volume and requires immediate attention; constant or intermittent real-time communication of level status to an operator or supervisor on-site or at a remote monitoring station; and camera feeds providing visual monitoring of the compartment from a monitoring location. One or more modes of notification may be used to provide redundancy, ensuring that appropriate care is taken to avoid overflow.

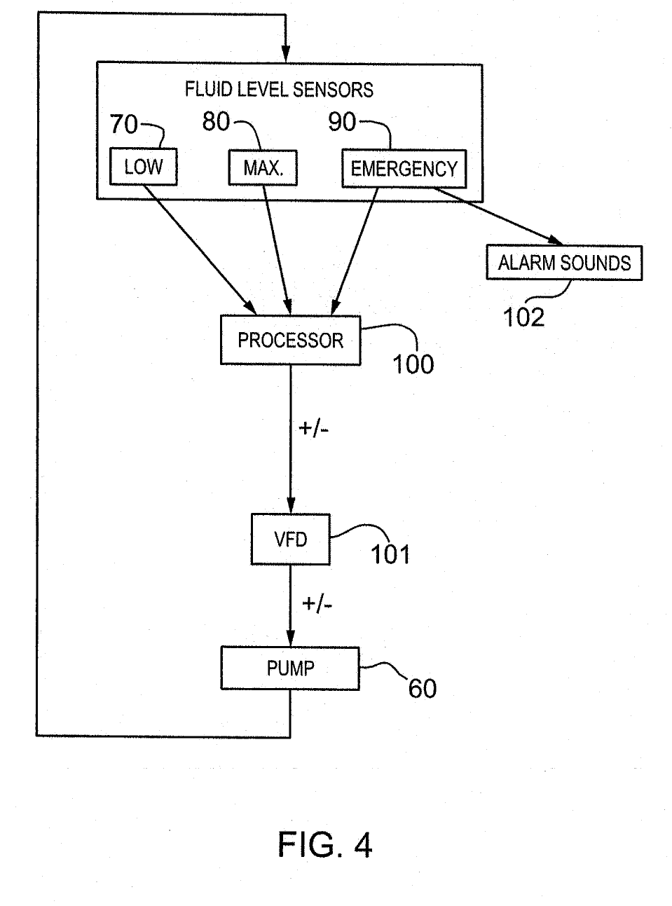

The monitoring and control system may be configured to adjust the rate of the pump 60 based on the sensed fluid volume within the compartment. FIG. 4 represents a process diagram for adjustment of the pump rate based on sensed fluid levels within the compartment. Fluid level sensors 70, 80, 90 are activated by contact with fluid such that when fluid is below the minimum fluid level A, none of the sensors will be activated. When fluid is within the normal working range (between minimum A and maximum B), only the minimum fluid sensor 70 will be activated. If fluid level is above normal maximum B, both the minimum fluid sensor 70 and maximum fluid sensor 80 will be activated. Should the fluid level reach the emergency level C, all three sensors 70, 80, 90, will be activated. Additionally, activation of the emergency level sensor 90 immediately triggers an alarm 102, to provide emergency feedback to the operator/driller in addition to rate monitoring. Further, site personnel may be receiving constant or intermittent fluid level readings so they may adjust other on-site process accordingly to avoid fluid overflow. For example, in drilling operations, the driller may receive constant notification of clarified fluid levels and settling tank fluid levels so drilling may be adjusted to avoid backup of fluids. Similarly, other on-site personnel may receive notifications so that appropriate manpower is available to assist with managing fluid conditions when necessary.

With respect to pump control, and with reference to FIG. 4, when none of sensors 70, 80, 90 are activated, the processor would recognize that the fluid volume in the compartment is too low and would run a preset low volume scheme to attempt to increase the fluid level. Such scheme may involve the VFD 101 reducing power to the pump 60, thereby slowing the rate of fluid exit from the fluid compartment 50. Alternatively, the motor may be shut down completely to avoid damage to the pump. In other embodiments, the scheme may simply be to turn the motor off rather than varying the speed, or to otherwise adjust flow accordingly.

Similarly, when fluid reaches the normal fluid maximum B, the processor would recognize this by activation of both sensors 70, 80, and run a high volume scheme, which may involve the VFD 101 increasing power to the motor 60, which would speed fluid exit from the compartment 50 to avoid overflow. If the increased pump speed is insufficient to reduce the fluid level (for example if the pump fails), the fluid within the compartment 50 will reach the emergency level C, which will immediately activate an alarm to notify operators of imminent overflow. Further, the processor will recognize activation of the emergency sensor 90 and may run an emergency scheme, implementing actions to avoid overflow such as termination of drilling or diversion of drilling fluid, tank fluid, and/or compartment fluid to a dump tank.

It should be understood that the clarified fluid compartment need not be a compartment within a settling tank, in which case the clarified overflow from the settling tank may be collected by alternate means. For example, the clear well may simply be a standalone compartment continuous with the uppermost portion of the final settling compartment, for example connected by a conduit. Appropriate configuration of the monitoring and control system and suitable schemes for adjusting the fluid volume within the clarified fluid compartment based on sensed levels will vary with alternate configurations of the settling tank and the clear fluid compartment as well as site requirements.

Moreover, it should be recognized that the present monitoring and control system may be used with any on-site tank for which overflow may be problematic. For example, each compartment of a settling tank may include a pump and level sensors. In such embodiments, the term “clarified fluid” within the above description would be replaced with “slurry fluid” or other term describing the fluid to be handled.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An environmental control system for use with a fluid compartment continuous with a settling tank, the environmental control system comprising: a stationary pump for removing fluid from the compartment; and a fluid volume monitoring and control system for adjusting operation of the pump based on the volume of fluid within the compartment.

2. The environmental control system as in claim 1, wherein the stationary pump comprises a submersible pump for placement within a fluid compartment; and a motor operatively attached to the pump so as to drive fluid removal from the compartment.

3. The environmental control system as in claim 2, wherein the motor is not submerged within tank fluid.

4. The environmental control system as in claim 3, wherein the fluid monitoring and control system comprises one or more fluid level sensors within the compartment.

5. The environmental control system as in claim 3, wherein the fluid monitoring and control system comprises notification means for communicating compartment fluid volume information to an operator.

6. The environmental control system as in claim 3, wherein the motor is operated by a variable frequency drive based on the fluid volume within the compartment.

7. The environmental control system as in claim 3, wherein the motor is operated by level switches within the compartment to maintain the fluid level within the compartment between predetermined limits.

8. The environmental control system as in claim 3, further comprising a processor for receiving volume data from the fluid compartment, and for initiating a preset adjustment scheme.

9. The environmental control system as in claim 8, wherein the preset adjustment scheme comprises adjusting the rate of flow from the compartment.

10. The environmental control system as in claim 8, wherein the preset adjustment scheme comprises activating an alarm.

11. The environmental control system as in claim 8, wherein the adjustment scheme comprises termination of a local fluid handling process.

12. The environmental control system as in claim 8, wherein the adjustment scheme comprises dumping of fluids from the compartment into a storage tank.

13. The environmental control system as in claim 8, wherein the adjustment scheme comprises dumping of fluids from the settling tank into a storage tank.

14. The environmental control system as in claim 1, wherein the fluid is drilling fluid.

15. The environmental control system as in claim 1, wherein the fluid is drilling slurry.

16. The environmental control system as in claim 1, wherein the fluid is drilling fluid that has been clarified by passage through the settling tank.

17. A method for preventing overflow of a fluid compartment continuous with a settling tank, the method comprising the steps of: placing a submersible pump within the fluid compartment, the submersible pump driven by a motor operatively attached to the pump by an impeller shaft such that the pump is operable by the motor without the motor being submerged within the compartment fluid; operating the pump to remove fluid from the compartment; sensing fluid volume within the compartment; and adjusting pump operation based on sensed compartment fluid volume.

18. The method as in claim 17, further comprising the step of communicating sensed fluid volume data to an operator.

19. The method as in claims 17, further comprising the step of: notifying an operator if the compartment fluid volume reaches a predetermined limit.

20. The method as in claim 17, further comprising the step of processing sensed fluid volume data and implementing a predetermined scheme to adjust compartment fluid volume.

21. The method as in claim 20, wherein the scheme comprises adjusting the amount of power to the motor.

22. The method as in claim 20, wherein the scheme comprises activation of an alarm.

23. The method as in any of claim 20, wherein the scheme comprises dumping of fluid from the compartment or from the settling tank.

24. The method as in claim 20, wherein the scheme comprises termination of a fluid handling process.

25. The method as in claim 18, wherein the operator is located remotely.
